(19) United States
(12) Patent Application Publication
(10) Pub. No.: US 2015/0301956 A1
(43) Pub. Date: Oct. 22, 2015

(54) DATA STORAGE SYSTEM WITH CACHING USING APPLICATION FIELD TO CARRY DATA BLOCK PROTECTION INFORMATION

(71) Applicant: LSI Corporation, San Jose, CA (US)

(72) Inventor: Saugata Das Purkayastha, Bangalore (IN)

(73) Assignee: LSI Corporation, San Jose, CA (US)

(21) Appl. No.: 14/261,476

(22) Filed: Apr. 25, 2014

Related U.S. Application Data
(60) Provisional application No. 61/982,701, filed on Apr. 22, 2014.

(51) Int. Cl. G06F 12/14; G06F 12/08

(52) U.S. Cl. CPC G06F 12/14; G06F 12/0848; G06F 2212/282; G06F 2212/1052

(57) ABSTRACT

In a data storage system in which a host system transfers data to a data storage controller having cache memory, the data storage controller can use a designated field of each of several cache data blocks, such as an application (APP) field, to contain protection information from fields of a host data block, such as the guard (GRD) and reference (REF) fields as well as the APP field.

### CROSS-REFERENCE TO RELATED APPLICATION

The benefit of the filing date of U.S. Provisional Patent Application No. 61/982,701, filed Apr. 22, 2014, entitled “DATA STORAGE SYSTEM WITH CACHING USING APPLICATION FIELD TO CARRY DATA BLOCK PROTECTION INFORMATION,” is hereby claimed and the specification thereof incorporated herein in its entirety by this reference.

### FIELD OF INVENTION

The invention relates generally to data storage systems and, more specifically, to data storage systems in which cached data blocks include protection information.

### BACKGROUND

As illustrated in FIG. 1, it is known that a host system 10, such as a computer, can store data in a data storage system comprising a storage controller 12 and a data storage device 14. Storage controller 12 can have any of various forms, such as a circuit card that plugs into a computer (e.g., host system 10). Storage controller 12 can be, for example, of the type commonly referred to as a host bus adapter (HBA). Storage controller 12 can include features such as cache memory 16. Although not shown for purposes of clarity, storage controller 12 and data storage device 14 may operate in accordance with RAID (Redundant Array of Independent (or Inexpensive) Disks) principles. Cache memory 16 can be of a volatile type such as dynamic RAM, a non-volatile type such as flash memory, or a combination of different types. Data storage device 14, which is sometimes referred to as back-end storage, can comprise one or more disk drives, flash memory modules, or other storage devices of the types commonly included in computer systems.

Cache memory 16 is configured to store data in units known as blocks 18, as indicated in broken line in FIG. 1. A common size for such a cache data block 18 is 512 bytes (B). Host system 10 commonly also processes data in units known as blocks, but the size of such a host data block 20 is commonly much larger than the 512 B of a cache data block 18. For example, host system 10 may be configured to process data in units of host data blocks 20 that are 4 kilobytes (kB) in size. Data storage device 14 may be configured to process data in units of storage device data blocks 22 of the same size as host data blocks 20, i.e., 4 kB. To facilitate caching, storage controller 12 can divide each host data block 20 into a number of cache data blocks 18. For example, in an instance in which each host data block 20 is 4 kB and each cache data block 18 is 512 B, storage controller 12 can divide each host data block 20 into eight cache data blocks 18. Thus, in a write operation initiated by host system 10, storage controller 12 controls the transfer of eight cache data blocks 18 (labeled “D” in FIG. 1) from host system 10 to cache memory 16 for each host data block 20 that host system 10 requests be written to storage device 14. The caching algorithm under which storage controller 12 operates determines the conditions that trigger storage controller 12 to initiate a transfer from cache memory 16 to storage device 14. Various caching algorithms are known. At such time as may be indicated by the caching algorithm, storage controller 12 reassembles eight cache data blocks 18 (“D”) that have been stored in cache memory 16 into a single storage device data block 22 and controls the transfer of that storage device data block 22 from storage controller 12 to storage device 14. Storage device 14 then stores the transferred storage device data block 22.

Data integrity extension or “DIX” is an approach intended to protect end-to-end data integrity in computer data storage systems, i.e., to protect data against media and transmission errors. The DIX approach involves including information known as protection information (PI) or data integrity fields (DIFs) along with each data block. As illustrated in FIG. 2, a host data block 24 is organized in the form of a user data field 26 and three PI fields: a guard (GRD) field 28, an application (APP) field 30, and a reference (REF) field 32. Although other DIX formats are known, PI consisting of a 2 B GRD field 28, a 2 B APP field 30, and a 4 B REF field 32 is set forth in the SBC-3 (SCSI Block Command Version 3) and SPC-4 SCSI Primary Commands) specifications promulgated by INCITS (International Committee for Information Technology Standards). User data 26 can be, for example, 4 kB in size.

The GRD field 28 carries the cyclic redundancy check (CRC) information computed for the user data contained in user data field 26. The contents of the APP field 30 are generally only meaningful to application software (i.e., a process executing on host system 10 that initiates the above-referenced write operation). The APP field 30 can carry, for example, a logical unit number or flags indicating block state or status. The REF field 32 commonly carries the logical block address (LBA) in storage device 14 at which host data block 24 is ultimately stored. Alternatively, the REF field 32 may carry an incremental count relating to the number of such host data blocks 24 that are transferred to storage device 14.

With reference to FIG. 2, during a write operation, a host system can append the eight bytes of PI consisting of the contents of GRD field 28, APP field 30, and REF field 32 to the user data contained in user data field 26. A storage controller that lacks caching of the type described above with regard to FIG. 1 would simply receive host data block 24 from the host system, verify the integrity of the user data against the associated PI, and transfer host data block 24 to the storage device if the verification test passes. Upon receiving host data block 24, the storage device would verify the integrity of the user data against the associated PI and, if the verification passes, would store the user data and associated PI as a storage device data block having a format or organization similar to host data block 24. Similarly, in a read operation, a storage controller that lacks caching would simply receive host data block 24 from the storage device, verify the integrity of the user data against the associated PI, and transfer the user data and PI in the form of host data block 24 to the host system if the verification passes. Upon receiving host data block 24 from the storage controller, the host system would similarly verify the integrity of the user data against the associated PI.

Reading and writing DIX-protected data (e.g., host data block 24) becomes problematic in the above-described system (FIG. 1) in which storage controller 12 includes caching. A problem arises because host data block 24 consists of 4 kB of user data and 8 kB of PI, but cache memory 16 is configured to store data in units of 512 B cache blocks 18. To accommodate the PI, some mechanism must be provided for caching the PI.

As illustrated in FIG. 3, one known method that facilitates writing and reading DIX-protected data among a host system 34, a storage controller 36 having a cache memory 40, and a data storage device 38 involves issuing a “FORMAT UNIT” SCSI command to data storage device 38 that sets an 8 B protection interval. A storage device 38 that is formatted in blocks 42 consisting of 512 B of user data and 8 B of PI (indicated by the cross-hatched fields in FIG. 3). During a write operation, host system 34 divides each 4 kB host data block 24 into eight 512 B blocks and appends the eight bytes of PI to each of the eight blocks to form eight cache data blocks 44 (“D”). Storage controller 36 then can receive the cache data blocks 44, verify the integrity of their user data against their PI, and store the cache data blocks 44 in cache memory 40. Storage controller 36 can control the transfer of the cache data blocks 44 from cache memory 40 to storage device 38. Storage device 38 then can verify the integrity of the user data contained in the cache data blocks 44 against their PI, and store the user data and PI as shown. This method facilitates caching data having associated PI because the format in which the data is stored, i.e., in blocks consisting of 512 B of user data plus 8 B of PI, is the same in both storage controller 36 and storage device 38.

Any data stored in storage device 38 at the time the SCSI “FORMAT UNIT” command is issued will be lost. Thus, in an instance in which storage device 38 contains data that is to be preserved at the time a DIX approach is to be adopted, this method would be undesirable. It would be desirable to provide a data storage system and method with caching that accommodates the DIX approach while avoiding data loss in the storage device.

### SUMMARY

Embodiments of the invention relate to a data storage system controller, method of operation, and computer program product, in which data blocks having data integrity extension information are cached by using fields of cache data block protection information (PI) to store fields of host data block PI.

In an exemplary embodiment, a method for data caching in a data storage system controller comprises: receiving a host data block from a host system, wherein the host data block comprises a data field, a first PI field configured for storing a first type of PI, and a second PI field configured for storing a second type of PI, and the data field of the host data block contains host data, the first PI field of the host data block contains first PI, and the second PI field of the host data block contains second PI; dividing the host data block into a plurality of cache data blocks including a first cache data block and a second cache data block, wherein each cache data block has a data field, a first PI field configured for storing the first type of PI, and a second PI field configured for storing the second type of PI; transferring a field of the host data contained in the host data block into the data field of each cache data block of the plurality of cache data blocks, wherein each data field of each cache data block contains a different field of the host data from the data field of all others of the cache data blocks; transferring the first PI contained in the first PI field of the host data block to the second PI field of the first cache data block; and storing the plurality of cache data blocks in a cache memory.

In the exemplary embodiment, a data storage system controller comprises a cache memory and a processing system that is programmed or configured to: receive a host data block from a host system, wherein the host data block comprises a data field, a first PI field configured for storing a first type of PI, and a second PI field configured for storing a second type of PI, wherein the data field of the host data block contains host data, the first PI field of the host data block contains first PI, and the second PI field of the host data block contains second PI; divide the host data block into a plurality of cache data blocks including a first cache data block and a second cache data block, wherein each cache data block of the plurality of cache data blocks has a data field, a first PI field configured for storing the first type of PI, and a second PI field configured for storing the second type of PI; transfer a field of the host data contained in the host data block into the data field of each cache data block of the plurality of cache data blocks, wherein each data field of each cache data block containing a different field of the host data from the data field of all others of the cache data blocks; transfer the first PI contained in the first PI field of the host data block to the second PI field of the first cache data block; and store the plurality of cache data blocks in the cache memory.

In the exemplary embodiment, a computer program product comprises a computer readable medium having stored thereon in computer executable non-transitory form instructions that, when executed on a processing system of a data storage system controller, cause the processing system to: receive a host data block from a host system, wherein the host data block comprises a data field, a first PI field configured for storing a first type of PI, and a second PI field configured for storing a second type of PI, wherein the data field of the host data block contains host data, the first PI field of the host data block contains first PI, and the second PI field of the host data block contains second PI; divide the host data block into a plurality of cache data blocks including a first cache data block and a second cache data block, wherein each cache data block of the plurality of cache data blocks has a data field, a first PI field configured for storing the first type of PI, and a second PI field configured for storing the second type of PI; transfer a field of the host data contained in the host data block into the data field of each cache data block of the plurality of cache data blocks, wherein each data field of each cache data block containing a different field of the host data from the data field of all others of the cache data blocks; transfer the first PI contained in the first PI field of the host data block to the second PI field of the first cache data block; and store the plurality of cache data blocks in the cache memory.

### BRIEF DESCRIPTION OF THE FIGURES

FIG. 1 is a block diagram illustrating a conventional data storage system with caching.

FIG. 2 illustrates a conventional host data block having PI.

FIG. 3 is a block diagram illustrating a conventional data storage system in which the storage device is formatted to accommodating cached data blocks having PI.

FIG. 4 is a block diagram illustrating a data storage system in accordance with an exemplary embodiment of the invention.

FIG. 5 illustrates dividing a host data block into cache data blocks and transferring PI from the host data block into the cache data blocks.

FIG. 6 is a flow diagram illustrating a method for caching write data, in accordance with the exemplary embodiment.

FIG. 7 is a flow diagram illustrating a method for caching read data, in accordance with the exemplary embodiment.

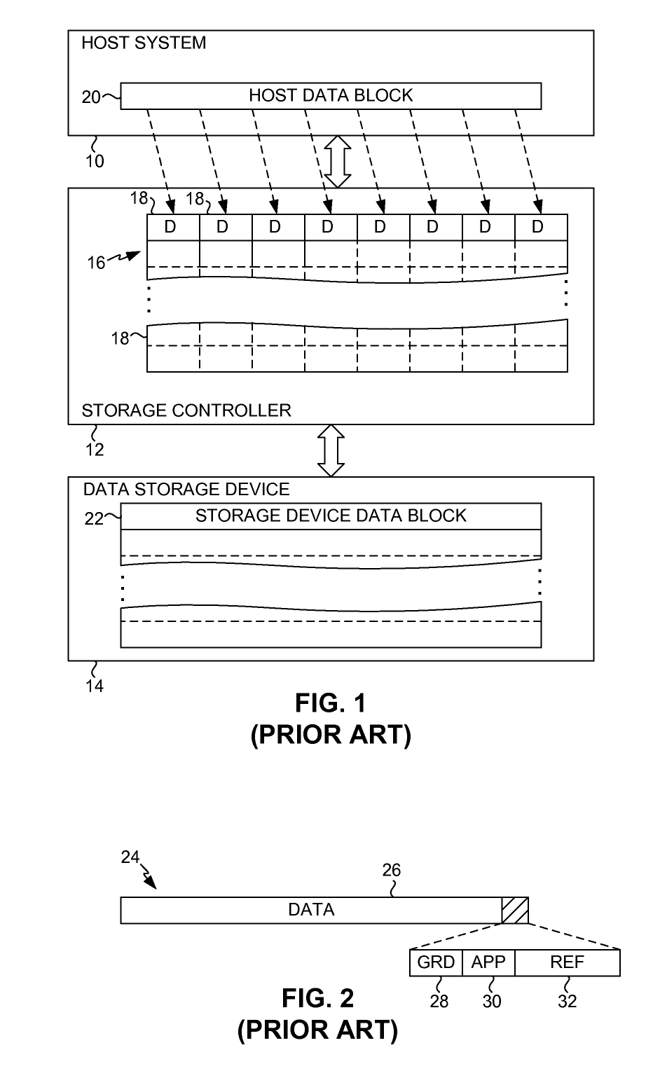

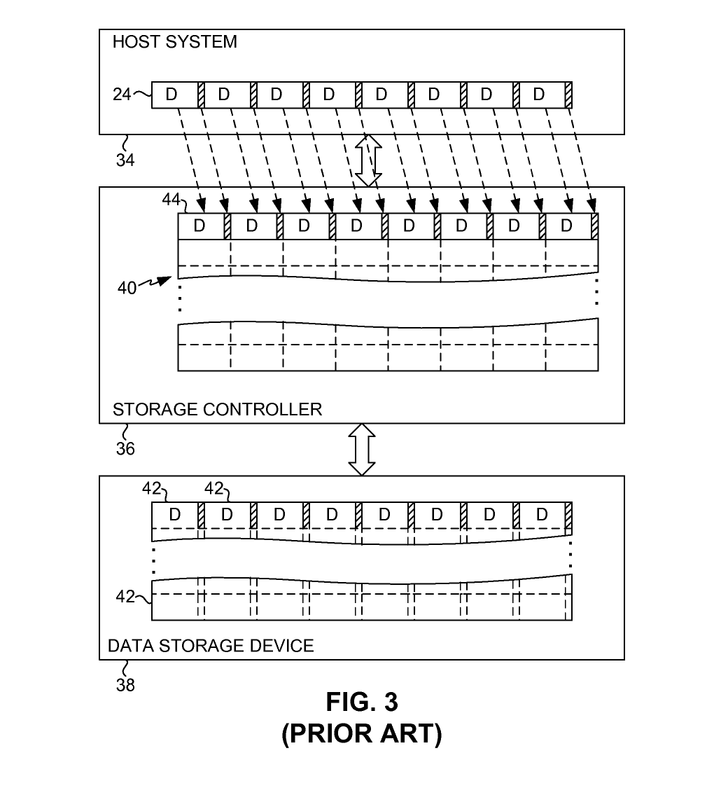

### WRITTEN DESCRIPTION

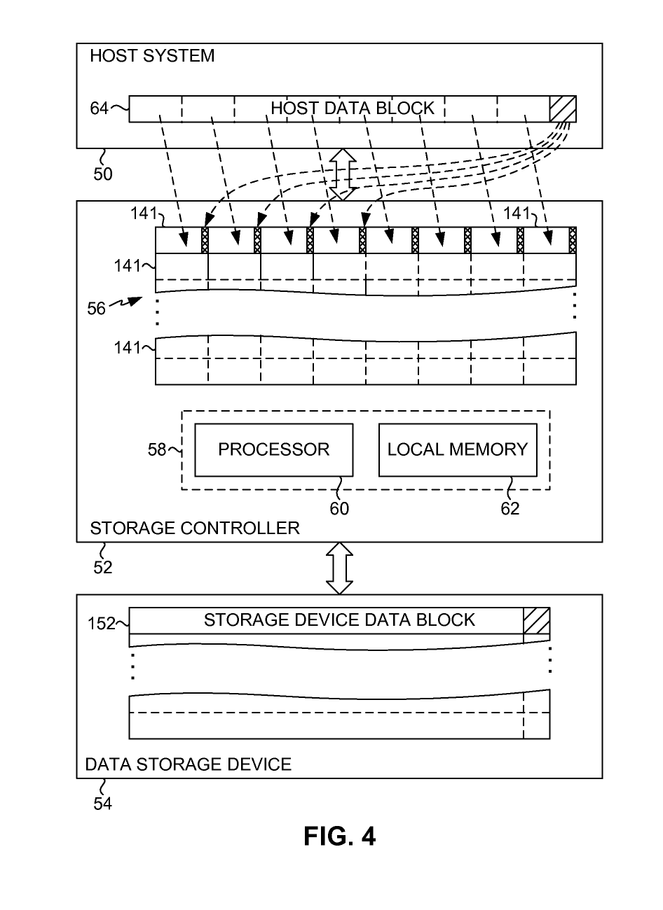

As illustrated in FIG. 4, a host system 50, such as a computer, can store data in a data storage system comprising a storage controller 52 and a data storage device 54. Storage controller 52 can comprise a host bus adapter (HBA) in the form of a circuit card that plugs into a computer (e.g., host system 50). However, in other embodiments such a storage controller can comprise any other suitable device. Storage controller 52 includes a cache memory 56. Cache memory 56 can comprise, for example, random-access memory (RAM). However, in other embodiments, such cache memory can comprise any other suitable type of volatile or non-volatile memory, such as flash memory. Storage controller 52 further includes a processing system 58 comprising one or more processors 60 and associated local memory 62. Local memory 62 can comprise any suitable type of memory that processors 60 can use to execute software for the purpose of effecting the methods described below, such as RAM. Data storage device 54 can comprise, for example, an array of disk drives having a RAID configuration. However, in other embodiments such a data storage device can comprise any other suitable type of drives, solid-state modules such as flash memory, or other storage devices of the types commonly included in computer systems. It should be understood that the data storage system operates not only in the manner described below but also in a conventional manner. For example, storage controller 52 can operate in accordance with RAID principles in storing data in data storage device 54. As such conventional aspects of the data storage system are well understood by persons skilled in the art, they are not described herein.

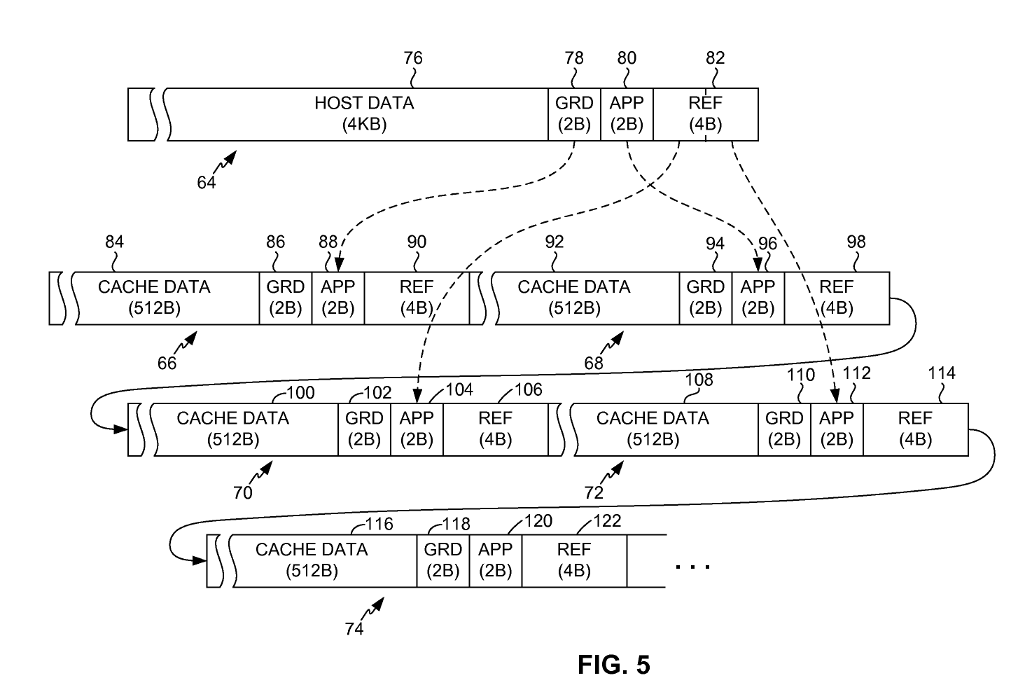

As illustrated in FIG. 5, an operational principle of the exemplary embodiment involves dividing a host data block 64 into a plurality of sequential cache data blocks 66, 68, 70, 72, 74, etc. In the exemplary embodiment, host data block 64 consists of a 4 kB host data field 76 and 8 B of protection information (PI) fields consisting of a 2 B guard (GRD) field 78, a 2 B application (APP) field 80, and a 4 B reference (REF) field 82. The foregoing field format of host data block 64 conforms to the SCSI SBC-3 and SPC-4 specifications. Although in the exemplary embodiment host data block 64 consists only of the foregoing fields, in other embodiments (not shown) such a host data block can comprise data fields of other sizes and PI fields of other types and sizes. More generally, exemplary embodiments of the invention can include a host data field and PI fields comprising at least a first PI field, a second PI field, and a third PI field. The first PI field is configured for storing a first type of PI, the second PI field is configured for storing a second type of PI, and the third PI field is configured for storing a third type of PI. The first, second and third types of PI are distinct or different from each other. Unless otherwise indicated herein as being a limitation in a particular instance, the terms “first,” “second,” “third,” etc., should not be construed as describing or implying a sequence or order. However, in the exemplary embodiment the first PI field is GRD field 78, which adjoins and immediately follows host data field 76, the second PI field is APP field 80, which adjoins and immediately follows GRD field 78, and the third PI field is REF field 82, which adjoins and immediately follows APP field 80. Also, as described below with regard to the transfer of data, the first cache data block 66, second cache data block 68, third cache data block 70, fourth cache data block 72, fifth cache data block 74, etc., are sequential.

In the exemplary embodiment: first cache data block 66 consists of a 512 B cache data field 84 and 8 B of PI fields consisting of a 2 B GRD field 86, which adjoins and immediately follows cache data field 84, a 2 B APP field 88, which adjoins and immediately follows GRD field 86, and a 4 B REF field 90, which adjoins and immediately follows APP field 88; second cache data block 68 consists of a 512 B cache data field 92 and 8 B of PI fields consisting of a 2 B GRD field 94, which adjoins and immediately follows cache data field 92; a 2 B APP field 96, which adjoins and immediately follows GRD field 94, and a 4 B REF field 98, which adjoins and immediately follows APP field 96; third cache data block 70 consists of a 512 B cache data field 100 and 8 B of PI fields consisting of a 2 B GRD field 102, which adjoins and immediately follows cache data field 100; a 2 B APP field 104, which adjoins and immediately follows GRD field 102, and a 4 B REF field 106, which adjoins and immediately follows APP field 104; fourth cache data block 72 consists of a 512 B cache data field 108 and 8 B of PI fields consisting of a 2 B GRD field 110, which adjoins and immediately follows cache data field 108; a 2 B APP field 112, which adjoins and immediately follows GRD field 110, and a 4 B REF field 114, which adjoins and immediately follows APP field 112; fifth cache data block 74 consists of a 512 B cache data field 116 and 8 B of PI fields consisting of a 2 B GRD field 118, which adjoins and immediately follows cache data field 116; a 2 B APP field 120, which adjoins and immediately follows GRD field 118, and a 4 B REF field 122, which adjoins and immediately follows APP field 120; etc. Further cache data blocks in the plurality of such cache data blocks into which the exemplary host data block 64 is divided are not shown for purposes of clarity but indicated by the ellipsis (“ . . . ”) symbol.

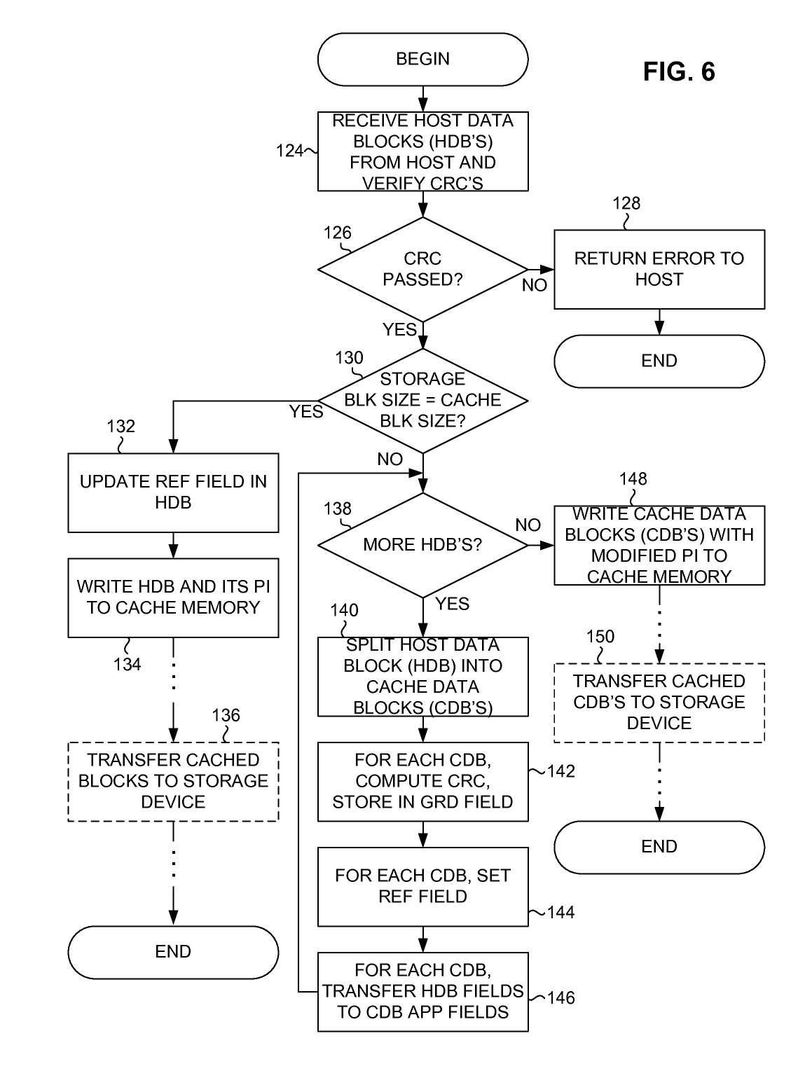

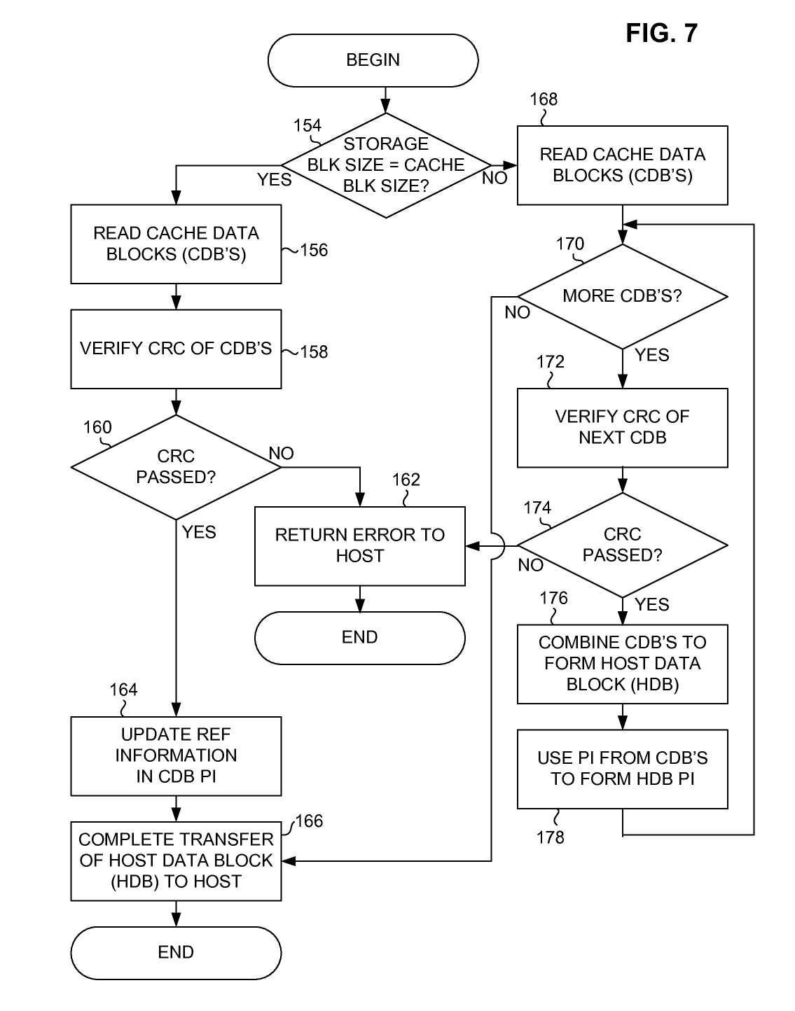

In the exemplary embodiment, processing system 58 of storage controller 52 (FIG. 4) is programmed or otherwise configured to cause storage controller 52 to effect the methods represented by the flow diagrams of FIGS. 6 and 7. In view of the descriptions herein, persons skilled in the art will be capable of providing suitable programming (e.g., software, firmware, etc.) and otherwise configuring storage controller 52 to effect the methods described herein. It should be noted that storage controller 52 operates in accordance with not only the methods described herein but also conventional methods, such as a caching method. As suitable caching methods are well understood by persons skilled in the art, this aspect is not described herein.

The flow diagram of FIG. 6 relates to an instance in which host system 50 (FIG. 4) initiates a write operation, also referred to as a write request. As indicated by block 124, the method begins with storage controller 52 receiving one or more host data blocks of the type described above with regard to FIG. 5. For example, storage controller 52 can receive host data block 64 (FIG. 5). Storage controller 52 uses the CRC value contained in GRD field 78 to verify whether storage controller 52 correctly received the host data contained in host data field 76. Although only a single exemplary host data block 64 is shown in FIG. 5 for purposes of clarity, it should be understood that storage controller 52 can receive more than one such host data block and can verify the CRC of each such host data block in the same manner. As indicated by block 126, storage controller 52 determines whether this verification test passed. If storage controller 52 determines that the verification test did not pass for a host data block, then storage controller 52 returns an error indication to host system 50, as indicated by block 128.

If storage controller 52 determines that the verification test passed for all host data blocks received from host system 50 in association with the write operation, then storage controller 52 determines whether data storage device 54 and cache memory 56 are configured to store data in blocks having the same size as each other, as indicated by block 130. For example, data storage device 54 and cache memory 56 can be configured to store data in blocks having the same size if data storage device 54 has been configured using a “FORMAT UNIT” SCSI command. If storage controller 52 determines (block 130) that data storage device 54 and cache memory 56 are configured to store data in blocks having the same size as each other, then storage controller 52 updates the REF field in the host data block (by, for example, setting the REF field to the logical block address (LBA) of the storage location in cache memory 56 in which the host data block is to be stored), as indicated by block 132. Storage controller 52 then writes the host data block (including its PI) to cache memory 56, as indicated by block 134. As indicated by block 136, at some later time as determined by a conventional caching method, storage controller 52 transfers portions of the data stored in cache memory 56 to storage device 54.

If storage controller 52 determines (block 130) that data storage device 54 and cache memory 56 are not configured to store data in blocks having the same size as each other, then the method proceeds in a looping or iterative manner, in which storage controller 52 processes each of the host data blocks it received. As indicated by block 138, storage controller 52 determines whether it has received host data blocks that it has not yet processed. If storage controller 52 determines (block 138) that there is another host data block to process, then as indicated by block 140 storage controller 52 divides the host data block into a plurality of cache data blocks of the type described above with regard to FIG. 5.

With regard to the example shown in FIG. 5, storage controller 52 can divide host data block 64 into eight cache data blocks 66, 68, 70, 72, 74, etc. (the remaining three of the eight cache data blocks in this example are not separately shown in FIG. 5 for purposes of clarity). In this example, storage controller 52 divides the host data block 64 into eight cache data blocks 66, 68, 70, 72, 74, etc., because the host data field 76 of host data block 64 is 4 kB in size, while cache memory 56 is configured to store cache data blocks that are each 512 B in size. Thus, eight cache data block locations 141 (FIG. 4) in cache memory 56 are required to store the host data contained in host data field 76 of host data block 64. Dividing host data block 64 into eight cache data blocks 66, 68, 70, 72, 74, etc., includes transferring or copying portions of the contents of the host data field 76 into the data fields 84, 92, 100, 108, 116, etc., of respective cache data blocks 66, 68, 70, 72, 74, etc. That is, the first 512 B of host data contained in host data field 76 is copied into data field 84 of first cache data block 66, the second 512 B of host data contained in host data field 76 is copied into data field 92 of second cache data block 68, the third 512 B of host data contained in host data field 76 is copied into data field 100 of third cache data block 70, etc., through the eighth 512 B of host data contained in host data field 76, which is copied into the data field of an eighth cache data block (not shown). This transferring or copying is conceptually indicated by straight broken-line arrows in FIG. 4. Note in FIG. 4 that each of cache data blocks 66, 68, 70, 72, 74, etc., is stored in one of the 512 B cache data block locations 141 in cache memory 56. The portion of the host data that is contained in each cache data block can be referred to as cache data.

Referring again to FIG. 6, storage controller 52 computes a CRC value for each cache data block, as indicated by block 142. With regard to the example shown in FIG. 5, storage controller 52 can compute CRC values from the cache data contained in cache data fields 84, 92, 100, 108, 116, etc., of cache data blocks 66, 68, 70, 72, 74, etc., respectively, and store the computed CRC values in respective GRD fields 86, 94, 102, 110, 118, etc. As indicated by block 144, storage controller 52 also can store suitable values in REF fields 90, 98, 106, 114, 122, etc., of cache data blocks 66, 68, 70, 72, 74, etc., respectively. As well understood by persons skilled in the art, a REF field can contain, for example, an LBA, a count or index identifying the position of the cache data block in the sequence, or other information.

As indicated by block 146, storage controller 52 transfers or copies PI contained in the host data block into the APP fields or similar second PI fields of two or more cache data blocks. Thus, contents of the first PI field of the host data block are transferred or copied to the second PI field of the first cache data block, contents of the second PI field of the host data block are transferred or copied to the second PI field of the second cache data block, contents of the third PI field of the host data block are transferred or copied to the second PI field of the third cache data block, etc. Note that although in the exemplary embodiment it is the second PI field of each cache data block (e.g., the APP field in data blocks conforming to SCSI SBC-3 and SPC-4 specifications) that receives the host data block PI, in other embodiments it can be any other suitable field of the cache data blocks that receives the host data block PI. It should be understood that the cache data block field that receives the host data block PI is the same field in each of the cache data blocks. Stated another way, the cache data block field that receives the host data block PI is configured to contain a type of PI that is distinct or different from the other types of PI. For example, all of the APP fields 88, 96, 104, 112, etc., of the respective cache data blocks 66, 68, 70, 72, etc., are configured to contain only the APP type of PI, which is distinct from the GRD type of PI and the REF type of PI. Though the APP fields of the cache data blocks are configured to contain only APP PI, the method described herein co-opts or adapts the APP fields of cache data blocks to instead contain the host data block PI consisting not only of APP host data block PI but also GRD host data block PI and REF host data block PI.

With regard to the example shown in FIG. 5, as conceptually indicated by curved broken-line arrows, storage controller 52: transfers the contents of GRD field 78 of host data block 64 to APP field 88 of first cache data block 66; transfers the contents of APP field 80 of host data block 64 to APP field 96 of second cache data block 68; transfers the high-order byte (i.e., one-half) of the contents of REF field 82 of host data block 64 to APP field 104 of third cache data block 70; and transfers the low-order byte (i.e., the other one-half) of the contents of REF field 82 of host data block 64 to APP field 112 of the fourth cache data block 72. Alternatively, in another embodiment storage controller 52 can transfer only the contents of GRD field 78 and APP field 80 of host data block 64 and not transfer the contents of REF field 82. Thus, in such an embodiment the contents of REF field 82 of host data block 64 is not saved in cache memory 56. Rather, storage controller 52 can generate any REF information that may be required, such as an LBA or a count, when transferring the data from cache memory 56 to storage device 54.

Once storage controller 52 determines (block 138) that there are no further host data blocks to process, then as indicated by block 148 storage controller 52 stores in cache memory 56 all of the cache data blocks into which the host data block has been divided, including those cache data blocks into which host data block PI has been transferred. As indicated by block 150, at some later time as determined by a conventional caching method, storage controller 52 transfers the data stored in cache memory 56 to storage device 54. Storage controller 52 can perform such a transfer by reassembling the information from the cache data blocks into a storage device data block 152 (FIG. 4). That is, storage device data block 152 includes the data and a portion of the PI contained in the cache data blocks. The format of storage device data block 152 can be the same as the format of host data block 64 and include the same PI fields.

With regard to the example shown in FIG. 5, data storage controller 52 can assemble the data field information for storage device data block 152 from the data contained in data fields 84, 92, 100, 108, 116, etc., of respective cache data blocks 66, 68, 70, 72, 74, etc. Data storage controller 52 can similarly transfer PI into the PI fields of storage device data block 152 (indicated as a cross-hatched region in FIG. 4). More specifically, storage controller 52 can transfer the GRD information from APP field 88 of first cache data block 66 to the GRD field (not separately shown) of storage device data block 152, transfer the host data block APP information from APP field 96 of second cache data block 68 to the APP field (not separately shown) of storage device data block 152, and transfer the host data block REF information from APP fields 104 and 112 of the third and fourth cache data blocks 70 and 72, respectively, to the REF field (not separately shown) of storage device data block 152, before transferring storage device data block 152 to storage device 54.

The flow diagram of FIG. 7 relates to an instance in which host system 50 initiates a read operation by requesting one or more data blocks. As indicated by block 154, storage controller 52 determines whether storage device 54 and cache memory 56 are configured to store data in blocks having the same size as each other. If storage controller 52 determines that storage device 54 and cache memory 56 are configured to store data in blocks having the same size as each other, then storage controller 52 reads the requested cache data blocks from cache memory 56, as indicated by block 156. Although not shown for purposes of clarity, a suitable conventional caching method can control the retrieval from storage device 54 of any cache data blocks that are not present in cache memory 56. As indicated by block 158, following reading the requested cache data blocks from cache memory 56, storage controller 52 can use the CRC value contained in the GRD field of each cache data block to verify whether storage controller 52 correctly received the host data contained in the host data field of the respective cache data block. As indicated by block 160, storage controller 52 determines whether this verification test passed. If storage controller 52 determines that the verification test did not pass, then storage controller 52 returns an error indication to host system 50, as indicated by block 162. If storage controller 52 determines that the verification test passed, then storage controller 52 can update the REF field of each cache data block (by, for example, setting the REF field to the logical block address (LBA) of the storage location in storage device 54 from which the data was retrieved), as indicated by block 164. Storage controller 52 then completes the transfer of the cache data blocks from cache memory 56 to host system 50, as indicated by block 166. Completing the transfer can include storage controller 52 assembling the data from the data fields of the cache data blocks into a host data block data field and generating the PI fields of the host data block before transferring the assembled host data block to host system 50.

If storage controller 52 determines (block 154) that data storage device 54 and cache memory 56 are not configured to store data in blocks having the same size as each other, then the method proceeds in a looping or iterative manner, in which storage controller 52 processes each of the cache data blocks read from cache memory 56. As indicated by block 168, storage controller 52 reads the requested cache data blocks from cache memory 56. As indicated by block 170, storage controller 52 determines whether it has read one or more cache data blocks that it has not yet processed. If storage controller 52 determines (block 170) that there is another cache data block that has been read from cache memory 56 but not yet processed, then as indicated by block 172 storage controller 52 computes a CRC value from the data field of the next cache data block and compares the computed value with the CRC value contained in the GRD field of that cache data block to verify it. As indicated by block 174, storage controller 52 determines whether this verification test passed. If storage controller 52 determines that the verification test did not pass, then storage controller 52 returns an error indication to host system 50, as indicated by block 162. If storage controller 52 determines that the verification test passed, then storage controller 52 combines or assembles the cache data blocks to form a host data block, as indicated by block 176.

With regard to the example shown in FIG. 5, data storage controller 52 can assemble the data field information for the requested host data block to be transferred to host system 50 from the data contained in data fields 84, 92, 100, 108, 116, etc., of respective cache data blocks 66, 68, 70, 72, 74, etc. As indicated by block 178, data storage controller 52 can similarly generate the PI fields for the requested host data block from the PI fields of cache data blocks 66, 68, 70 and 72. For example, storage controller 52 can transfer the CRC value from the APP field 88 of the first cache data block 66 to the GRD field of the host data block, transfer the APP information from the APP field 96 of the second cache data block 68 to the APP field of the requested host data block, and transfer the REF information from the APP fields 104 and 112 of the third and fourth cache data blocks 70 and 72, respectively, to the REF field of the host data block before transferring the host data block to host system 50.

If storage controller 52 determines (block 170) that all cache data blocks that have been read from cache memory 56 in response to the read request have been processed in the manner described above with regard to blocks 172-176, then storage controller 52 completes the transfer of the cache data blocks from cache memory 56 to host system 50 in the form of the assembled HDB, as indicated by block 166.

It should be understood that the flow diagrams of FIGS. 6 and 7 are intended only to be exemplary or illustrative of the logic underlying the described methods. Persons skilled in the art can appreciate that in various embodiments processing system 58 of storage controller 52 can be programmed or configured in any of various ways to effect the described methods. The steps or acts described above with regard to FIGS. 6 and 7 can occur in any suitable order or sequence, including in parallel or asynchronously with each other in some instances. Steps or acts described above with regard to FIGS. 6 and 7 can be combined with others or omitted in some embodiments. Although depicted for purposes of clarity in the form of two separate flow diagrams in FIGS. 6 and 7, the underlying logic can be modularized or otherwise arranged in any suitable manner. Persons skilled in the art will readily be capable of programming or configuring processing system 58 with suitable software or in suitable logic, such as in the form of an application-specific integrated circuit (ASIC) or similar device or combination of devices, to effect the above-described methods. Also, it should be understood that the combination of software instructions or similar logic and the local memory 62 or other memory in which such software instructions or similar logic is stored or embodied for execution by processor 60, comprises a “computer-readable medium” or “computer program product” as that term is used in the patent lexicon.

It should be noted that the invention has been described with reference to one or more exemplary embodiments for the purpose of demonstrating the principles and concepts of the invention. The invention is not limited to these embodiments. As will be understood by persons skilled in the art, in view of the description provided herein, many variations may be made to the embodiments described herein and all such variations are within the scope of the invention.

What is claimed is:

1. A method for data caching in a data storage system controller, comprising:
receiving a host data block from a host system, the host data block comprising a data field, a first protection information field configured for storing a first type of protection information, and a second protection information field configured for storing a second type of protection information, the data field of the host data block containing host data, the first protection information field of the host data block containing first protection information, and the second protection information field of the host data block containing second protection information;
dividing the host data block into a plurality of cache data blocks including a first cache data block and a second cache data block, each cache data block of the plurality of cache data blocks having a data field, a first protection information field configured for storing the first type of protection information, and a second protection information field configured for storing the second type of protection information;
transferring a portion of the host data contained in the host data block into the data field of each cache data block of the plurality of cache data blocks, each data field of each cache data block containing a different portion of the host data from the data field of all others of the cache data blocks;
transferring the first protection information contained in the first protection information field of the host data block to the second protection information field of the first cache data block; and
storing the plurality of cache data blocks in a cache memory.

2. The method of claim 1, wherein the first type of protection information is a cyclic redundancy check, and the second type of protection information is not a cyclic redundancy check.

3. The method of claim 2, wherein:
the first protection information field of the host data block is a data integrity extension guard field; and
the second protection information field of the host data block is a data integrity extension application field.

4. The method of claim 1, further comprising transferring the second protection information contained in the second protection information field of the host data block to the second protection information field of the second cache data block.

5. The method of claim 4, wherein the first type of protection information is a cyclic redundancy check, and the second type of protection information is not a cyclic redundancy check.

6. The method of claim 5, wherein:
the first protection information field of the host data block is data integrity extension guard field; and
the second type of protection information of the host data block is a data integrity extension application field.

7. The method of claim 1, wherein the host data block further comprises a third protection information field configured for storing a third type of protection information, the third protection information field of the host data block contains third protection information, each cache data block of the plurality of cache data blocks further comprises a third protection information field configured for storing the third type of protection information, and the method further comprises transferring the third protection information contained in the third protection information field of the host data block to the second protection information field of the third cache data block.

8. The method of claim 7, wherein:
the third protection information field of the host data block has a size twice a size of the second protection information field of each of the cache data blocks; and
transferring the third protection information comprises transferring a first half of the third protection information contained in the third protection information field of the host data block to the second protection information field of the third cache data block and transferring a second half of the third protection information contained in the third protection information field of the host data block to the second protection information field of the fourth cache data block.

9. The method of claim 8, wherein:
the first protection information field of the host data block is data integrity extension guard field configured for storing a cyclic redundancy check value;
the second protection information field of the host data block is a data integrity extension application field; and
the third protection information field of the host data block is a data integrity extension reference field.

10. A data storage controller, comprising:
a cache memory; and
a processing system programmed or configured to:
receive a host data block from a host system, the host data block comprising a data field, a first protection information field configured for storing a first type of protection information, and a second protection information field configured for storing a second type of protection information, the data field of the host data block containing host data, the first protection information field of the host data block containing first protection information, and the second protection information field of the host data block containing second protection information;
divide the host data block into a plurality of cache data blocks including a first cache data block and a second cache data block, each cache data block of the plurality of cache data blocks having a data field, a first protection information field configured for storing the first type of protection information, and a second protection information field configured for storing the second type of protection information;
transfer a portion of the host data contained in the host data block into the data field of each cache data block of the plurality of cache data blocks, each data field of each cache data block containing a different portion of the host data from the data field of all others of the cache data blocks;
transfer the first protection information contained in the first protection information field of the host data block to the second protection information field of the first cache data block; and
store the plurality of cache data blocks in the cache memory.

11. The data storage controller of claim 10, wherein the first type of protection information is a cyclic redundancy check, and the second type of protection information is not a cyclic redundancy check.

12. The data storage controller of claim 11, wherein:
the first protection information field of the host data block is a data integrity extension guard field; and
the second protection information field of the host data block is a data integrity extension application field.

13. The data storage controller of claim 10, wherein the processing system is further programmed or configured to transfer the second protection information contained in the second protection information field of the host data block to the second protection information field of the second cache data block.

14. The data storage controller of claim 13, wherein the first type of protection information is a cyclic redundancy check, and the second type of protection information is not a cyclic redundancy check.

15. The data storage controller of claim 14, wherein:
the first protection information field of the host data block is a data integrity extension guard field; and
the second protection information field of the host data block is a data integrity extension application field.

16. The data storage controller of claim 10, wherein the host data block further comprises a third protection information field configured for storing a third type of protection information, the third protection information field of the host data block contains third protection information, each cache data block of the plurality of cache data blocks further comprises a third protection information field configured for storing the third type of protection information, and the processing system if further programmed or configured to transfer the third protection information contained in the third protection information field of the host data block to the second protection information field of the third cache data block.

17. The data storage controller of claim 16, wherein:
the third protection information field of the host data block has a size twice a size of the second protection information field of each of the cache data blocks; and
the processor is programmed or configured to transfer the third protection information by transferring a first half of the third protection information contained in the third protection information field of the host data block to the second protection information field of the third cache data block and transferring a second half of the third protection information contained in the third protection information field of the host data block to the second protection information field of the fourth cache data block.

18. The data storage controller of claim 17, wherein:
the first protection information field of the host data block is data integrity extension guard field configured for storing a cyclic redundancy check value;
the second protection information field of the host data block is a data integrity extension application field; and
the third protection information field of the host data block is a data integrity extension reference field.

19. A computer program product comprising computer readable medium having stored thereon in computer executable non-transitory form instructions that, when executed on a processing system of a data storage system controller, cause the processing system to:
receive a host data block from a host system, the host data block comprising a data field, a first protection information field configured for storing a first type of protection information, and a second protection information field configured for storing a second type of protection information, the data field of the host data block containing host data, the first protection information field of the host data block containing first protection information, and the second protection information field of the host data block containing second protection information;
divide the host data block into a plurality of cache data blocks including a first cache data block and a second cache data block, each cache data block of the plurality of cache data blocks having a data field, a first protection information field configured for storing the first type of protection information, and a second protection information field configured for storing the second type of protection information;
transfer a portion of the host data contained in the host data block into the data field of each cache data block of the plurality of cache data blocks, each data field of each cache data block containing a different portion of the host data from the data field of all others of the cache data blocks;
transfer the first protection information contained in the first protection information field of the host data block to the second protection information field of the first cache data block; and
store the plurality of cache data blocks in a cache memory of the data storage controller system.
